(19) United States
(12) Patent Application Publication
(10) Pub. No.: US 2002/0032656 A1
(43) Pub. Date: Mar. 14, 2002

(54) System and method for providing automatic teller machine services to multiple financial institutions

(76) Inventor: Christopher Y. Chen, Los Angeles, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/818,824

(22) Filed: Mar. 27, 2001

Related U.S. Application Data
(60) Provisional application No. 60/193,800, filed on Mar. 31, 2000.

(51) Int. Cl. G06F 17/60

(52) U.S. Cl. 705/43

(57) ABSTRACT

A method and a system for providing automatic teller machine (“ATM”) services to the customers of multiple financial institutions where the financial institutions contract with an ATM services provider. The ATM services provider providing multiple ATM's which are connected to an electronic funds transfer network. In an exemplary embodiment, the contracting financial institutions pay fees to the services provider in return for the services provider providing the financial institutions' customers with reduced or no cost ATM access. By contracting out the same set of ATMs to multiple financial institutions, the ATM services provider reduces duplicate ATM costs incurred when each financial institution maintains its own ATM network. Preferably, each of the ATMs of the ATM services provider has similar distinguishing characteristics or “trade dress” so as to make the ATM services provider's ATMs readily distinguishable from other ATMs. The ATM services provider may maintain a database of information about the customers and financial institutions including, but not limited to, the account numbers, the financial institution identification numbers, the transaction histories, and the contractual arrangements for determining the amount of reduced fees to be charged to the financial institutions and their customers. The service provider's ATMs may provide all conventional ATM transactions including, but not limited to, withdrawals of cash, inquiries of account balances, transfers of balances, and deposits of monies and checks.

### CROSS-REFERENCE TO RELATED APPLICATION(S)

This application claims the benefit of U.S. Provisional Patent Application No. 60/193,800 filed on Mar. 31, 2000, entitled AUTOMATIC TELLER MACHINE PROVIDER SYSTEM AND METHOD FOR PROVIDING AUTOMATIC TELLER MACHINE SERVICES, the contents of which are incorporated herein by reference.

### BACKGROUND OF THE INVENTION

ATMs were first introduced in the 1960's, and became widely adopted by financial institutions and accepted by cardholders in the 1980's. Today, ATMs are a vital distribution channel for financial institutions, providing cost savings over human tellers and other branch operations, and an important benefit to cardholders, who now have access to their funds 24 hours a day. According to a study by Booz, Allen & Hamilton, the cost of processing a transaction through a live teller is almost four times the cost of that for an ATM.

The importance of ATMs as a distribution channel for financial institutions can be illustrated by the pervasiveness of cardholder usage and machine deployment. National studies show that, today, 33 percent of all financial transactions are now done through an ATM. The number of ATM cards has grown to over 200 million. The number of ATMs deployed nationwide has grown from 18,500 in 1980 to 227,000 in 1998. Dove Associates, a consulting firm with expertise in the financial services industry, predicts ATM deployment to grow 10 percent per year over the next five years. The annual number of transactions has grown at a compound annual growth rate of 9.3 percent from 4.5 billion in 1988 to 10.9 billion in 1998. However, as a consequence of the rapid deployment of ATMs, the average number of transactions per machine has declined from 6,580 in 1995 to 3,997 in 1999.

The increase in ATM usage and availability was facilitated by the opening of shared ATM networks. Several years ago, the ATM fleets operated by financial institutions were proprietary networks that were available to only their own customers, as shown in FIG. 1a. The development of the electronic funds transfer (“EFT”) networks helped to open up these proprietary systems. Today, a consumer can use an ATM owned by a financial institution in which he is not a customer if his financial institution and the ATM are members of the same EFT network. As shown in FIG. 1b, the EFT networks manage the flow of funds and the communications between different financial institutions. An EFT network is a network that has connections with financial institutions to allow electronic transfer of funds between those participating member financial institutions. There are both national and regional networks. National EFT networks include Cirrus (owned by MasterCard) and Plus (owned by Visa) and regional EFT networks include Star Systems, PULSE, NYCE and MAC, among others. ATMs and financial institutions usually participate with a combination of national and regional EFT networks. The EFT networks are back-end networks, mostly unseen to the consumer.

A side-effect of the new open networks was the advent of the surcharge fee, a fee charged to the consumer for the convenience of using an ATM owned by any entity other than the consumer's financial institution. ATM surcharging became widespread starting in April 1996 when the national EFT networks, Cirrus and Plus, changed their policies to allow surcharging at ATMs. The change in surcharge policy has resulted in the rapid deployment of ATMs at off-premise or off-branch locations. While the massive deployment of ATMs has made accessing one's financial institution account more convenient, as a whole, it has created many inconveniences to a large portion of customers who must pay surcharges every time they use another financial institution's ATM, as shown in FIG 1b.

Generally, ATM users will seek out ATMs that have minimum, preferably zero, transaction costs. However, if the benefits of a low cost transaction with an ATM are outweighed by the costs of inconvenience (e.g., distance to travel, effort to find, etc.) for using that ATM, the user uses an ATM owned by another party for a surcharge. The surcharge phenomenon has created a competitive advantage for larger financial institutions with the financial wherewithal and larger customer bases to deploy extensive numbers of ATMs in convenient locations. Smaller financial institutions, with fewer ATM locations, will inherently be less convenient to the typical consumer. As a result, smaller financial institutions are thereby less able to retain existing customers and acquire new customers. The following is a table showing the disparity of ATM deployment among financial institutions of various sizes:

TABLE 1
Distribution of Financial Institution ATM Ownership

| | Median | | Cumulative |
|---|---|---|---|
| | Number of | Percent of | Percent of |
| | ATMs | ATMs Owned | ATMs owned |
| 76 largest financial | 440 | 37% | 37% |
| institutions | | | |
| Next 414 largest | 43 | 32% | 69% |
| financial institutions | | | |
| Remaining 7700 | | | |
| smallest financial | 3 | 31% | 100% |
| institutions | | | |

The difference in competitive positioning has created additional fees to consumers. As shown in FIG. 1c, larger financial institutions now impose “foreign” fees or “off-us” fees to their own customers when they use another financial institution's ATM. In this case, the consumer must now pay two fees: a surcharge fee charged by the ATM owner, and a foreign or off-us fee charged by their own financial institution. Typically, the foreign or off-us fee is between $1.00 and $1.50 and appears on the consumer's monthly statement from his financial institution as opposed to appearing on the ATM receipt.

The surcharge fees charged by large institutions have forced many small institutions to absorb additional costs to retain customers. Since many smaller financial institutions cannot afford to deploy ATMs at a cost of $20,000 to $25,000 per ATM per year, they have resorted to reimbursing their customers for surcharge fees incurred when using another financial institution's ATM, as shown in FIG. 1d. These smaller financial institutions are forced to reimburse their customers to remain competitive with the ATM convenience provided by larger financial institutions with large ATM fleets.

There are three basic business models that exist in the ATM market today. In the first model, ATMs are owned and/or operated by financial institutions such as banks. Under this model, each financial institution owns a fleet of its own ATMs, which are free to its own customers or account holders. As shown in FIG. 1a, bank A's customers use bank A's ATMs at no cost to the customer. Financial institutions drive their customers to their own machines by providing ATM access free of charge. This is a demand-driven model where customers will search out their own financial institution's ATMs because they are free for them to use. As a result, the transaction volumes at financial institution ATMs are five to ten times the level of that of ATMs deployed by independent sales organizations (“ISOs”) which charge all users a surcharge.

The ATMs of Bank B are also available to Bank A's customer for use. However, Bank A's customer, as well as Bank A, must pay costs and fees associated with the transaction. A surcharge fee is a fee charged by the ATM owner and paid by the cardholder for using an ATM of an ISO or using ATM services on an account that is not associated with the financial institution of the ATM used. An interchange fee is a fee charged by an ATM owner to a non-accountholder's home financial institution for handling one of its transactions. The Cirrus System EFT network charges $0.50 for each cash withdrawal transaction and $0.25 for each non-cash withdrawal transaction, such as a balance inquiry. A switch fee is a fee assessed by an ATM electronic funds transfer network to a cardholder's home financial institution to pay for processing each of its transactions and to defray other operating costs, such as advertising and security. Typically, the switch fee is between $0.04 and $0.10 per transaction.

A variation of the first model is when an ATM is owned and/or operated by another entity, such as an independent sales organization, and branded under the name of a particular bank. The bank's customers can utilize these ATMs for free just like they can utilize the other ATMs that the bank owns and/or operates. The ISO may be compensated in various ways including a per transaction fee, a flat management, or combination, thereof. Because the ATMs are branded under the bank's name, all consumers perceive that the ATM is owned and/or operated by the specific bank. The perception is that only the customers of the one contracting bank can receive ATM transactions for free at those ATMs. The disadvantage of such a system is that customers may perceive the ATMS branded in such manner are free exclusively for customers of that financial institution, but to no others.

In the second model, ATMs are owned and/or operated by independent sales organizations. ISOs are not affiliated with a financial institution. ISOs do not operate their ATMs like a network. Instead, ISOs operate their ATMs like stand-alone vending machines and charge each and every customer for using the machine. A vending machine operates on convenience without leveraging the relationships between one machine and other machines. In addition, this is a need-based model, where customers only use these ATMs when given no other choice. Under this model, all customers must pay a surcharge fee of $1.50 or more to execute a transaction at an ATM owned by an independent operator. Generally, the surcharge fees at independent ATMs are much higher than those at ATMs owned by financial institutions.

In the third model, there are “no surcharge” ATM alliances of financial institutions where each of the institutions contribute at least a part of their ATMs for use by the customers of the other institutions in the alliance without imposing a surcharge. Generally, usage of each of the ATMs under the alliance will increase because customers will deliberately visit participating alliance ATMs because they are free. This model is an attempt by smaller financial institutions to combat the competitive advantage that larger financial institutions have because of their much larger and more extensive networks of ATMs. In this model, customers of all of the member financial institutions of a coalition or alliance can use the ATMs owned and designated by the member financial institutions as surcharge-free ATMs at no cost.

However, there are disadvantages associated with such an alliance. First, the ATMs of the alliance are not uniformly identifiable under one brand. Instead, each ATM is individually branded under the name of the financial institution that owns the particular ATM. This is problematic because it is difficult for the customer to remember the thousands of financial institutions that comprise a typical alliance. Second, some alliances allow participating financial institution members to designate only a portion of their ATMs as being surcharge free. This requires customers to not only identify a financial institution as being a member of an alliance, but customers must further determine whether a particular ATM is one of those designated as being surcharge free. The end result being additional inconvenience for the customer. Third, typically large and medium size financial institutions do not participate in an ATM alliance because of the disproportionate share of ATMs contributed by the large and medium size financial institutions as compared with those contributed by the smaller financial institutions. Finally, many of the ATMs that the alliance financial institution members possess are not located in high-traffic, convenient locations. Therefore, significant efforts on the part of the customer are required to find and locate an alliance ATM. Rather than readily knowing from a distance that a particular ATM is a participating alliance ATM, the customer must search in a brochure or website beforehand or approach the ATM to determine whether or not the ATM is a participating alliance ATM.

The overall problem with the above models is that the customer and/or the customer's financial institution must pay a surcharge more often than they should because the customer does not have access to enough free ATMs. What is needed therefore is a system and method for providing small financial institutions with the ability to offer their customers surcharge free or low cost access to large network of ATMs. Preferably, all of the ATM's in the network should have the same distinctive brand name and trade dress, thereby rendering them readily identifiable to customers.

### SUMMARY OF THE INVENTION

In an exemplary embodiment of the present invention, an ATM services provider provides ATM services to multiple financial institutions, or other entities providing financial services, for the benefit of the customers of the financial institution. The ATM service provider maintains control of multiple ATMs, which are connected to an EFT network, while providing ATM services under contract to the financial institutions. The ATM services provider provides all conventional ATM transactions including, but not limited to, cash withdrawal, balance inquiries, balance transfers, and deposit of money for the customers of the financial institutions. In the exemplary embodiment, the ATM service provider provides all conventional ATM transactions except deposit of money. In another embodiment, the ATM service provider additionally acts as a check clearing house for all of the financial institutions under contract with the service provider and thereby additionally offers deposit of funds in the form or checks or currency at its ATM's. In a further embodiment, the ATM services provider may offer check cashing services at its machines.

All of the ATMs of the ATM services provider preferably have the same distinguishing characteristics or “trade dress” so as to make the services provider's ATMs readily distinguishable from other ATMs. The net effect is to build a brand identity for the services provider's ATMs, thus rendering the services provider's ATMs readily recognizable to customers. The ATM services provider generates revenue by charging contracting financial institutions access fees instead of charging the respective customers a surcharge every time the customers use one of the services provider's ATMs. The services provider further generates revenue through the collection of EFT network interchange fees. Although it is expected that the system and method of the present invention will allow small financial institutions to provide ATM services to their customers at little or no cost to the customers, the services provider also provides the contracting financial institutions with the option of imposing a surcharge on their customers in order to fully or partially offset the fees charged by the services provider. The services provider further provides the financial institutions with the option of varying the surcharge over discrete geographic regions.

The ATM services provider creates many benefits to both the contracting financial institutions and their customers. By giving customers free or low cost ATM services from a large number of easily recognizable ATMs, the financial institutions offer their customers convenient ATM access, while lowering their own costs by avoiding the time-consuming burden of creating and/or expanding their own separate networks of ATMs. The ATM services provider also allows contracting financial institutions to have access to a far greater number of ATMs than they could own and operate on their own. The ATM services provider further allows contracting financial institutions to immediately expand into new geographic regions without building their own physical infrastructure or having a physical presence in those new markets. These and other features of the invention will become more apparent from the following detailed description of the invention, when taken in conjunction with the accompanying exemplary drawings.

### BRIEF DESCRIPTION OF THE DRAWINGS

FIG. 1a is a diagram illustrating the prior art wherein an ATM is operated by a financial institution and is available only to the customers of that financial institution.

FIG. 1b is a diagram illustrating the prior art wherein an ATM of Bank B is made available to customer's of Bank A at a cost to Bank A and Bank A's customer, and wherein an EFT network manages the flow of funds and the communications between different financial institutions.

FIG. 1c is a diagram illustrating the prior art wherein when customers of a large financial institution (Bank A) use another financial institution's (Bank B's) ATM, Bank A's customers pay surcharge fees to Bank B and “foreign” fees or “off-us” fees to Bank A.

FIG. 1d is a diagram illustrating the prior art wherein when customers of a financial institution (Bank A) use another financial institution's (Bank B's) ATM, Bank A's customers pay surcharge fees to Bank B and are reimbursed for the surcharge fees by Bank A.

FIG. 2 is a diagram illustrating the present invention wherein an ATM service provider has both a business-to-consumer (B2C) component and a business-to-business component (B2B).

FIG. 3 is a diagram illustrating an embodiment the present invention wherein when customers of a contracting financial institution (Bank A) use ATMs of the ATM service provider, Bank A's customers do not pay a surcharge fee, and Bank A pays access, switch and interchange fees to the EFT network and/or the ATM service provider.

FIG. 4 is a flow chart depicting a typical operating procedure for an ATM of the ATM services provider.

FIG. 5 depicts a typical ATM card.

FIG. 6 depicts a schematic representation of a database of financial institutions under contract with the ATM services provider.

FIG. 7 depicts a schematic representation of a database of individual consumers under contract with the ATM services provider.

FIG. 8 is a flow chart depicting the procedure allowing individual consumers to contract with the ATM services provider.

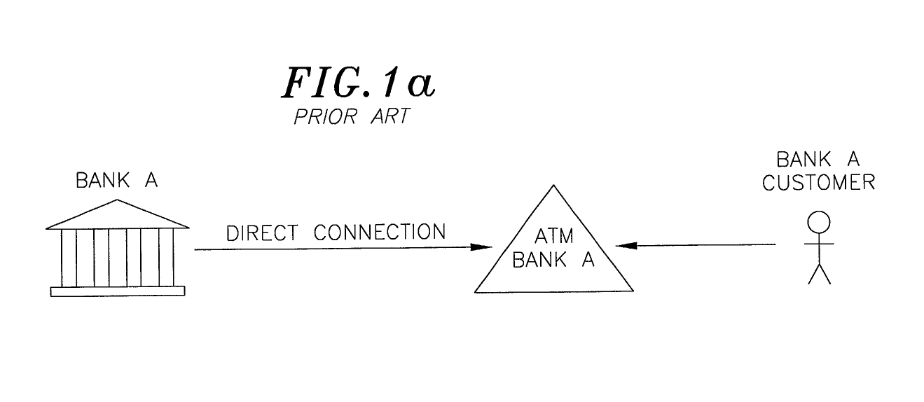

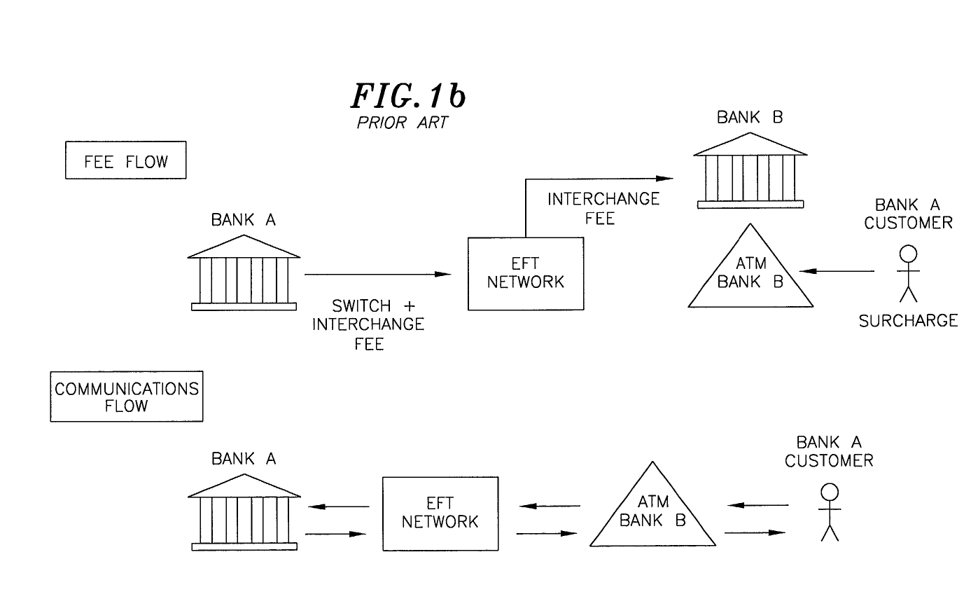

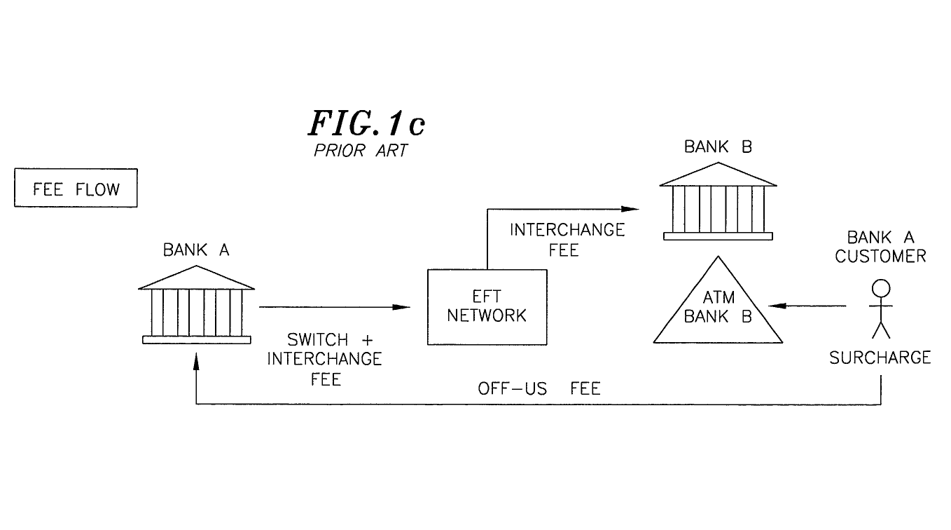

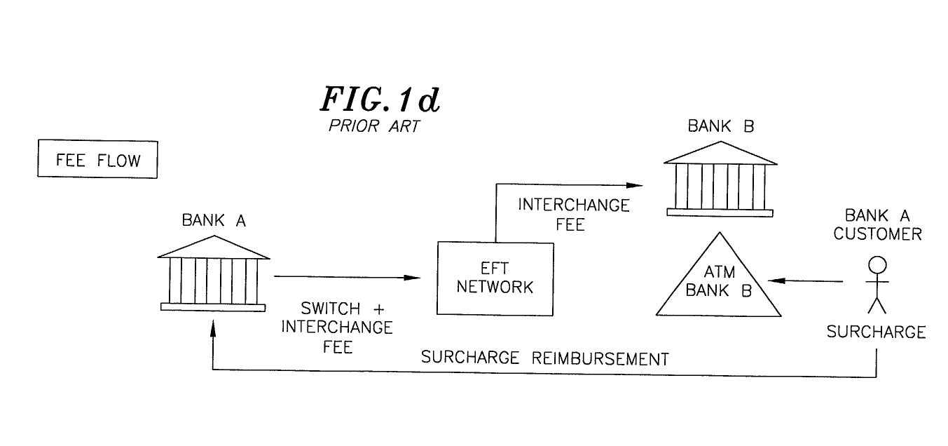

### DETAILED DESCRIPTION OF THE INVENTION

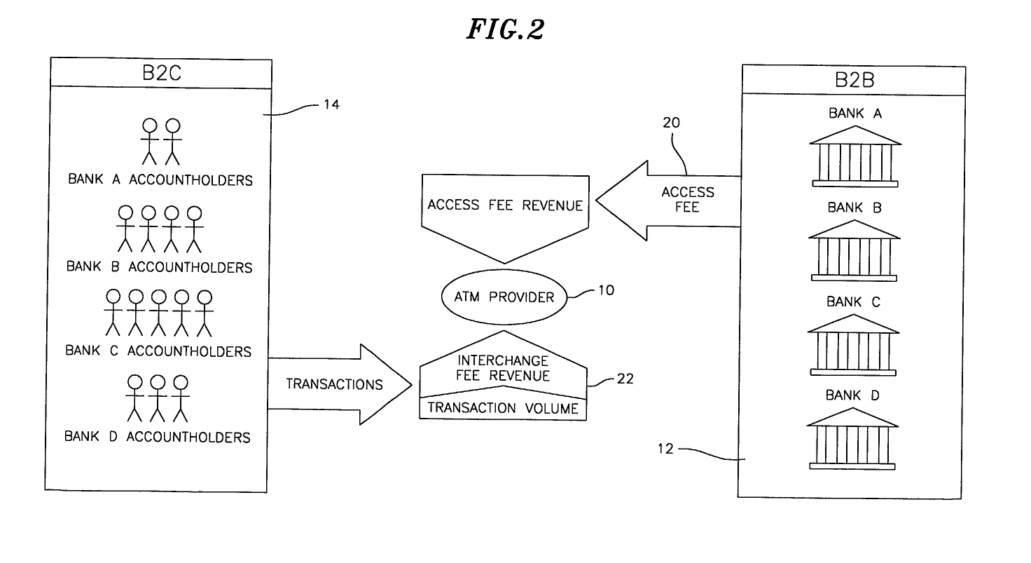

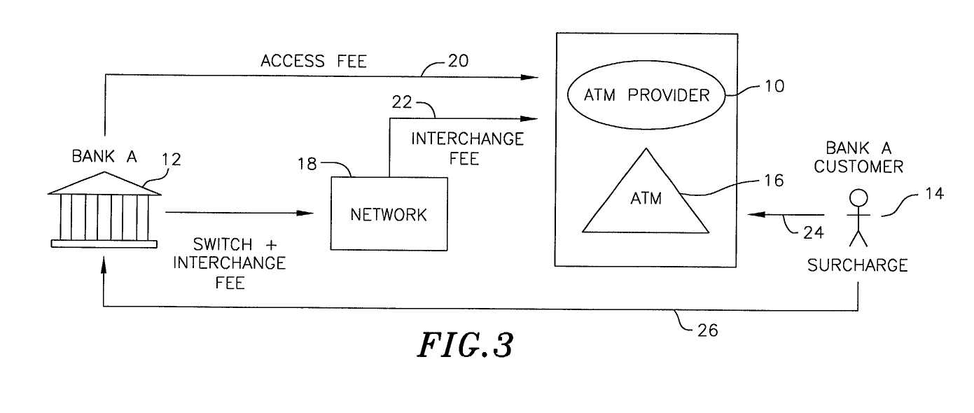

Referring to FIGS. 2 and 3, in one exemplary embodiment of the system and method of the present invention, an ATM services provider 10 contracts with a plurality of financial institutions 12, having a plurality of customers 14, to provide ATM services to the customers of the financial institutions. Throughout this specification reference will be made to the term financial institution. A financial institution may include, without limitation, banks, credit unions, savings and loans, brokerage houses, mutual fund houses, insurance companies, firms engaged in banking and investment services over the Internet, and any other entity which may desire to provide financial services to its customers through an ATM network.

The ATM services provider 10 provides multiple ATMs 16, where the ATM's are connected to a network 18. The number of ATM's may vary from at least two ATM's to several million or more ATMs, which may be connected in a local, regional, national, or worldwide network. The ATM's may be connected to a proprietary electronic funds transfer (“EFT”) network owned or controlled by the ATM services provider and/or the ATM's may be connected an existing EFT network such as the CIRRUS and PLUS networks owned by Mastercard and Visa respectively. Preferably the ATM network is national in scope and is subdivided into predetermined geographic regions, such as state and county level networks. The ATM services provider provides all conventional ATM transactions including cash withdrawal, balance inquires, balance transfers, and deposit of money. In the exemplary embodiment, the ATM services provider provides all conventional ATM transactions except deposit of money. In another embodiment, the ATM services provider also accepts currency and check deposits and provides check clearing services to the contracting financial institutions. In a further embodiment, the ATM services provider may provide check cashing services at its ATMs.

With continued reference to FIGS. 2 and 3, in the exemplary embodiment of the present invention, the ATM services provider 10 preferably offers free ATM access to the customers 14 of the contracting or participating financial institutions 12. Preferably, the ATM services provider generates a majority of its revenue from access fees 20 and EFT network interchange fees 22 which are paid by the contracting financial institutions. The ATM services provider may generate a portion of its revenue from a per transaction surcharge 24 imposed upon customers of the contracting financial institutions. In addition, a particular financial institution may impose, or direct the ATM provider to impose, a per transaction “off-us” or foreign fee 26 on its customers to partially or wholly offset the cost of the ATM transactions. It is expected that in some locales, such as sparsely populated regions which lack sufficient transaction volume to otherwise support an ATM, such surcharges may be required. Further, some financial institutions may wish to provide free ATM access to their customers in certain geographic regions and may wish to provide access for a fee in other regions. Also, some financial institutions may desire to provide a predetermined number of free transactions on a periodic basis and charge a fee for transactions in excess of the predetermined number in any particular period.

The ATM services provider 10 improves upon the closed ATM networks maintained by large financial institutions, wherein the ATMs are accessible free of charge only to the customers of the large institution, by providing ATMs 16 which are distinguished by a common trade dress and which are accessible to any financial institution 12 contracting with the ATM services provider. The customers of each particular contracting financial institution 14 may have free of charge access to all of the ATMs of the ATM provider, or to a subset of the provider's ATMs, at the discretion of their particular financial institution. The system and method of the present invention allows small financial institutions with limited ATM networks, or no ATM's at all, to provide their customers with free of charge access to an extensive network of ATMs of a geographic scope previously only available through large financial institutions. Thus, the present invention ATM system and method promotes competition by allowing small financial institutions to offer ATM services equivalent to those offered by large financial institutions. The ATM services provider may serve as an extension of a particular financial institution's existing network of ATMs or may serve as the primary cash delivery system for those financial institutions without their own ATM networks. In one embodiment, each ATM of a contracting financial institution may be purchased by the ATM services provider and be incorporated in the services provider's ATM network.

The ATM services provider 10 also provides benefits to financial institutions with existing ATM networks of large and intermediate size. Today, there is substantial duplication in ATM placement among competing financial institutions and ISOs. Frequently, competing financial institutions with overlapping territories have placed their ATMs in close proximity to the ATMs of competitor institutions. This is particularly prevalent in desirable high traffic locations. This has resulted in an overall redundancy in ATMs and excessive costs. There are fixed overhead costs associated with operating an ATM. The overhead costs are spread out over each transaction and added to an individual transaction cost to give a total transaction cost. As the number of transactions increase per ATM, the total cost per transaction decreases. Therefore, by eliminating redundant ATMs, the ATM services provider can increase transaction volume at the services provider's ATM. The net effect is to decrease the fixed costs per ATM transaction. For this reason, even large financial institutions may prefer to contract with the ATM services provider in order to realize the cost savings that may be achieved by eliminating redundant ATMs.

In addition, with the redundant ATMs removed, ATM access is typically improved for the customers. ATM access is typically improved because desirable high traffic locations generally may accommodate only a limited number of ATMs and therefore some financial institutions regardless of size will be locked out of some high traffic locations due to lack of the space needed to place additional ATMs. Again, smaller financial institutions particularly benefit by being able to provide ATM services to their customers in desirable locations where they would not have the resources to provide their own ATMs. In sum, by providing one ATM in place of several, the cost per transaction decreases. As a result, the financial institutions will likely have more customers retained and acquired at lower cost, and thus, more profits.

The ATM services provider business model has both a business-to-consumer (B2C) component and a business-to-business component (B2B) as shown in FIG. 2. From the B2C standpoint, the ATM services are typically provided free of charge to customers 14 of the participating financial institutions 12. The ATM services provider 10 is viewed from the consumer perspective as a “brand name” ATM network. By providing transactions for free, or at reduced cost, customers of the participating financial institutions will actively search out and use the ATMs of the ATM services provider on a regular and frequent basis. From the B2B side, significant costs to the financial institutions that are associated with operating their own ATM networks are avoided, i.e., financial institution clients will no longer need to operate any of their own ATMs.

As stated previously, in the exemplary embodiment, the customers 14 of the contracting financial institutions 12 preferably do not pay any surcharges to the ATM services provider 10 for using the service provider's ATMs 16. Instead, the primary revenue source for the ATM services provider is from the access and interchange fees, 20 and 22, paid by the financial institution of the customer, as shown in FIG. 3. An access fee is the fee charged to the financial institution for each transaction conducted by a customer of the financial institution. For financial institutions that are under contract with the ATM services provider, the access fee is less than the full surcharge rate charged by competitor banking entities for access to their proprietary ATM networks. As a result, the ATM services provider reduces the overall costs of ATM access to most parties, i.e., ATM services are preferably free to customers of contracting financial institutions and the per transaction costs for the contracting financial institutions are generally lower than the prevailing full surcharge rate. Access fees can be charged to the participating financial institutions in several ways. The access fees may be charged on a per customer basis rather than on a per transaction basis. The fees may also be charged on a periodic fixed or flat fee basis. Both the access fee and the EFT transaction fee may vary with respect to the type of transaction performed. The above examples are representative only. Other methods of charging access fees are possible.

In another embodiment, a particular financial institution may choose to impose a modest surcharge assigned on an ATM-by-ATM, or geographic region-by-geographic region, basis. For example, a particular financial institution with operations in only one state may want to provide free access for its customers to the services provider's ATMs which are located only in the state in which the financial institution operates. The particular financial institution may further wish to provide its customers with ATM access in other states at a modest surcharge, which is preferably below the prevailing rate charged by large institutions. The system of the present invention allows for the provision of free and/or surcharged ATM access on a local, state or nationwide basis, as best suits the needs of a particular contracting financial institution.

By offering ATM services to customers for free, and having a large customer base associated with the multiple financial institutions, the ATM services provider's transaction volume is driven up to a level that will more than compensate for the comparatively low fees assessed on each transaction by the ATM services provider. A higher volume of transactions at each of the services provider's ATMs leads to reduced operating costs for each institution, as the fixed costs of operating an ATM decline with increased transaction volume. Typical ATM operating costs may include, lease of the ATM machine, rent of location space, telecommunications and data processing costs, employee salaries, cash pickup and replenishment service, and machine maintenance costs. Despite these substantial costs, the cost of ATM transactions are generally lower than the costs associated with teller service.

Because the ATM services provider offers free access to the customers of contracting financial institutions, the customers will in general travel greater distances to use the services provider's ATMs in order to avoid paying a surcharge fee. As a result, the ATMs of the ATM services provider may be able to expand transaction volumes to levels similar to bank “off-premise” ATMs, i.e., ATMs owned by a financial institution but placed away from financial institution property, such as in malls, retail stores and other high-traffic locations. Bank “off-premise” ATMs have about 2,600 monthly transactions, where the ATMs of ISOs typically average less than 500 monthly transactions.

Potential clients of the ATM services provider may include, but are not limited to, brokerage firms, insurance companies, Internet financial institutions, small and medium-sized traditional financial institutions and credit unions. These financial institutions typically do not provide an ATM in a certain location without first having a customer base to support the ATM network in those locations. Some financial institutions, such as Internet financial institutions and brokerage firms, may have customer bases that are geographically dispersed which makes it difficult and, in many cases, economically unfeasible, to deploy a network of ATMs that will be utilized sufficiently.

As a physical delivery system for getting cash to consumers, the ATM services provider provides a cost-effective and sustainable solution for smaller financial institutions. The ATM services provider offers several value propositions to these financial institutions including lower ATM-related costs, higher customer retention and customer acquisition rates, and increased assets. The ATM services provider further lowers the direct costs for financial institutions that currently reimburse their customers for surcharges because the access fees are less than the surcharge fees charged by most ATMs.

By increasing the convenience level to consumers several-fold, the ATM services provider helps contracting financial institutions retain their existing customers and acquire new customers at much higher success rates. The ATM service provider also helps contracting financial institutions keep customers who change residences, as the financial institutions will continue to be able to provide customers with convenient access to their accounts through the ATMs that the ATM services provider has in other geographic regions. With positive net new customers, the asset base for these financial institutions will increase. Finally, some financial institutions will experience increased asset acquisition as customers consolidate their assets into a single financial institution. For instance, brokerage firms, which currently provide significantly higher interest rates compared to that of banks will be able to offer convenient access to cash by contracting with the ATM services provider, making brokerage firms ideal centers for personal asset consolidation.

The ATM services provider will have a prominently displayed brand name and appearance that is easily recognized and understood by customers to represent free ATM access. The ATMs preferably have similar distinguishing characteristics, i.e, “trade dress”, including similar logos, so that customers may easily recognize the ATMs of the ATM services provider. In one preferred embodiment, the “brands” or “marks” of contracting financial institutions are not displayed on the ATMs of the ATM services provider so as to avoid any customer confusion. In another embodiment, the “brands” or “marks” of contracting financial institutions are displayed only on the monitor when a customer inserts/swipes his ATM card into the ATM.

The ATMs of the ATM services provider are preferably placed in retail chain stores, office buildings, malls, airports, and other high traffic locations that are habitual stops for customers. As a result, the customers are able to conduct their banking transactions on a regular and convenient basis. Placing the ATMs in retail chain stores has the advantages of both the high-traffic real estate that those stores have purchased, and the widely recognized chain store name. As a result, the ATM of the ATM services provider are convenient to the customer, and the customer is able to associate the ATM with those retail chain stores. Once a customer knows that the ATM services provider is in every such chain store, the customer can easily find the ATMs of the ATM services provider. Additionally, or alternatively, the ATMs of the ATM services provider are placed in convenience-oriented shops and/or smaller “mom or pop” stores.

In one embodiment, the ATM services provider contracts with “e-cash” entities, such as PayPal, or another escrow type account. The ATMs are used to access the cash distributed from the e-cash entities. E-cash refers to money held in electronic form, for example money placed on a smart card, instead of traditional checks, money orders, and cashier's checks. For example, the ATM services provider allows customers to access cash from an e-cash account by withdrawing their cash through the services provider's ATMs rather than receiving a check from the e-cash entity. The customers may access their cash with a typical ATM card. Alternatively, the customers can receive a code via the Internet or other medium and use this code at an ATM of the ATM services provider to access their cash. The ATM services provider may also allow customers to add funds to a smart card, or other stored value card, by deducting the added funds from the customer's financial institution account.

In another embodiment, an individual customer's usage pattern is tracked. Based on the usage pattern, ads are customized and/or delivered to the customer. For example, if a customer lives in Los Angeles and visits an ATM of the ATM services provider in Chicago, the ATM services provider has a database which identifies the personal characteristics of the customer, such as the preferred language of the transaction, the financial institution the customer is affiliated with, the type of usage of the ATM as well as the ATM location. The database also tracks whether the customer is associated with a financial institution that has a free-ATM use policy, or whether the customer has an account where there are charges for ATM use. Based upon the information in the services provider's database, the services provider may provide custom tailored advertising (hotels, restaurants, etc.) likely to interest the customer during his out of town trip.

In yet another embodiment, ATM services provider may also provide check clearing services to the contracting financial institutions, thereby allowing check deposits by customers of the financial institutions even though a particular deposit may be geographically remote from the particular financial institution designated to receive the deposit. In another embodiment, the ATM service provider may be equipped with check readers so as to provide check cashing services to customers. Check cashing machines are known to those skilled in the art. U.S. Pat. No. 6,1454,738, describes one such system.

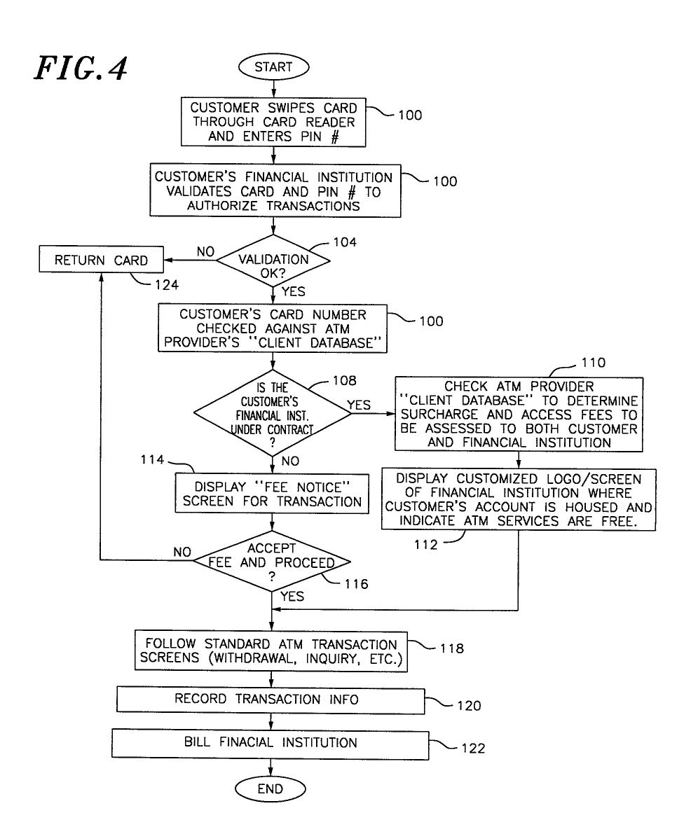

Referring now to FIG. 4, a typical process for using the ATM machines of the ATM service provider will be described. Initially, in step 100, a customer inserts an ATM card 128 (FIG. 5) in the ATM service provider's machine and subsequently enters his personal identification number (“PIN”). In step 102, the ATM contacts, via an EFT or similar network, the customer's financial institution to validate the card and PIN in order to authorize transactions. In step 104, the ATM receives the validation response, if the answer is yes, the ATM proceeds to step 106, if the answer is no, the ATM proceeds to step 124 where the customer's ATM card is returned.

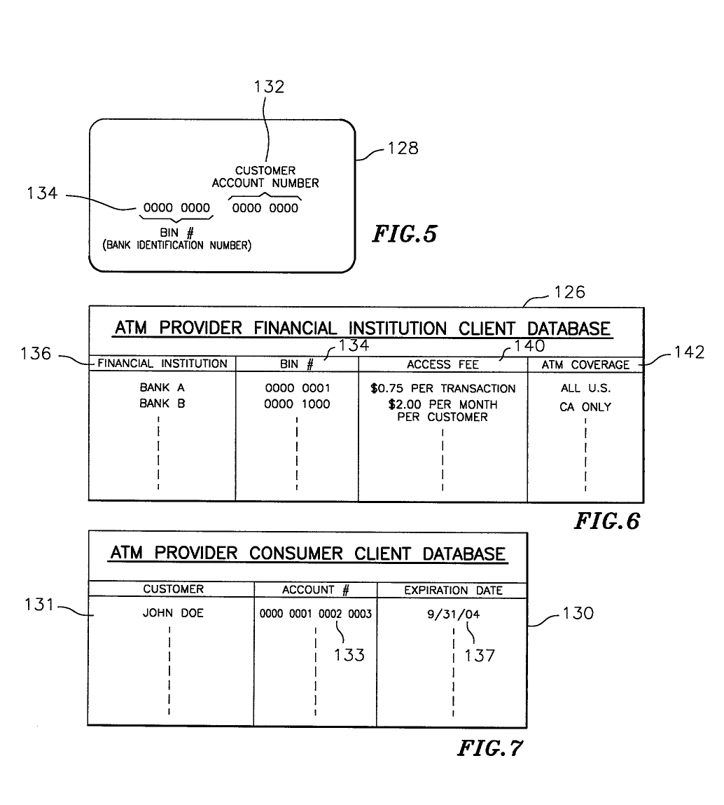

In step 106, the customer's card number is checked against a client data base 126 (FIG. 6). In step 108, the ATM queries the client database to determine whether the customer's financial institution is under contract with the ATM services provider, if the answer is yes, the ATM proceeds to step 110. In step 110, the client database 126 is again queried to determine the surcharge, if any, that is to be charged to the customer and access fee that is to be charged to the contracting financial institution. In step 112, the ATM generates a display depicting the contracting financial institution's logo and trade dress and informs the customer of which ATM services are available, and what fees, if any, will be assessed for those services and then proceeds to step 118.

In step 118, the ATM generates typical transaction display screens which are well known to those skilled in the art. After the customer makes his desired transaction, the ATM proceeds to step 120. In step, 120 information regarding the transactions which occurred in step 118 are transmitted to the customer's financial institution. In step 120, the customer's financial institution is billed for the ATM services. If the customer's financial institution is a contracting financial institution, that institution is billed as provided in its contract with the ATM services provider. Non-contracting financial institutions are billed a surcharge which is typically immediately charged and collected via an EFT network.

Referring again to step 108, if the answer is no, the customer's financial institution is not under contract with the ATM services provider, the ATM machine proceeds to step 114. In step 114, the ATM displays a “fee notice,” that is, the ATM informs the customer that a fee will be assessed for the transaction. In step 116, the customer may accept or reject the fee. If the customers accepts the fee, the ATM proceeds to step 118 and proceeds to process the transaction. If the customer rejects the fee, the ATM proceeds to step 124 and returns the customers ATM card.

FIG. 6 depicts a schematic representation of the contracting financial institution database 126 maintained by the ATM services provider. This database includes a compilation of the contracting financial institutions 136, a compilation of bank identification numbers (“BIN”) 134 associated with each financial institution, a compilation of the access fees 140 to be charged to each respective financial institution, and an indicator 142 of the geographic regions for which service is to be provided for each contracting financial institution. The database may be housed at the ATM terminals, at a central database management center, at intermediate centers, or a combination thereof.

Referring now to FIG. 5, the typical ATM card 128 is displayed. The card will typically include a customer account number 132 and a bank identification number (“BIN”) 134. This information may be recorded on a magnetic strip affixed to the card or by other means known to those skilled in the art.

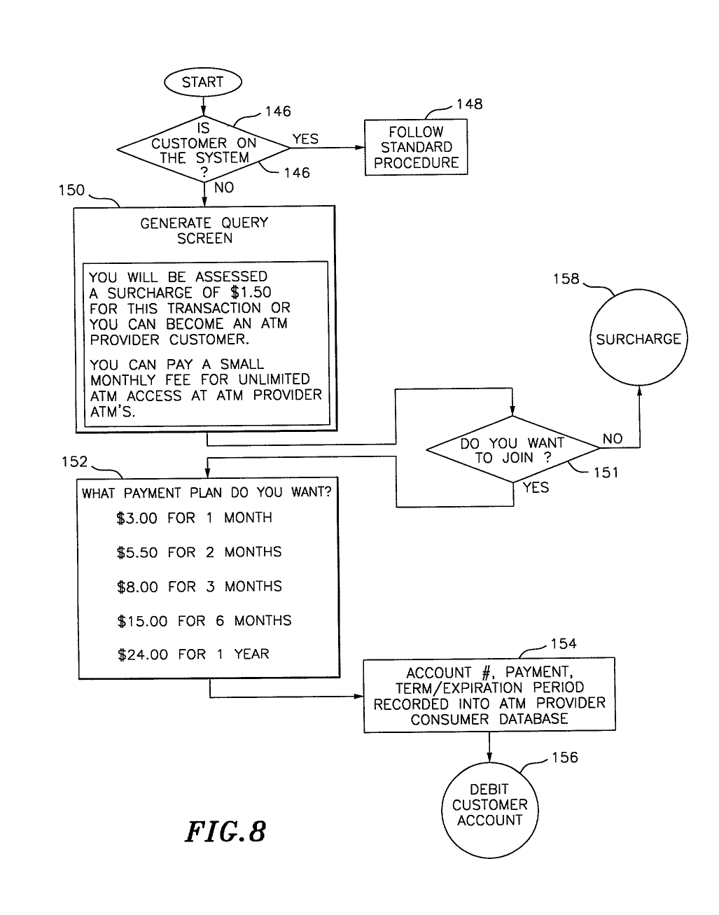

In another embodiment, customers of non-participating financial institutions, or customers of participating financial institutions which provide limited free access to the service provider's network, may contract directly with the ATM services provider for expanded access to the network. The customer is given the option of signing up for unlimited access to the ATMs of the services provider for a flat fee over a designated period of months, such as three months. Such access may be granted directly from one of the services provider's ATMs. The customer's usage may be tracked and a statement may be printed out for the customer that calculates savings from joining the ATM network plan. FIG. 8, depicts a typical customer sign-up procedure. In step 146, the ATM ascertains whether the customer is from a participating financial institution. If the answer is yes, the ATM proceeds to step 148 and continues with typical transaction processing procedures described with reference to FIG. 4 above. If the answer is no, the ATM proceeds to step 150. In step 150, the ATM generates a query screen explaining that the customer has the option of joining the ATM services provider's network. In step 151, the customer is asked if wants to join the ATM services provider's network. If the answer is no, the ATM proceeds to step 158, where a surcharge is imposed upon the customer. If the answer is yes, the ATM proceeds to step 152. In step 152, the ATM generates a display screen depicting the customer's options for joining the services provider's system. In step 154, the ATM records the customers account information and sign up option in a consumer client database 130 (FIG. 7) maintained by the ATM services provider. In step 156, the ATM machine debits the customers account in accordance with the sign-up option chosen by the customer.

FIG. 7 depicts a schematic representation of the consumer client database 130 maintained by the ATM services provider. This database includes at least a compilation 131 of the consumers who have elected to sign-up with the ATM services provider, a compilation 140 of the account numbers associated with each respective consumer, and a compilation 137 of the expiration dates upon which the each consumers service option expires. The consumer client database may be organized as a subset of the contracting financial institution database 126.

While only the presently preferred embodiments have been described in detail, as will be apparent to those skilled in the art, modifications and improvements may be made to the system and method disclosed herein without departing from the scope of the invention. Accordingly, it is not intended that the invention be limited except by the appended claims.

What is claimed is:

1. A system for providing ATM services comprising:
an ATM service provider, the provider providing at least two ATMs, wherein the ATMs are connected to a network;
a plurality of financial institutions, each financial institution having a plurality of customers, wherein each financial institution contracts with the ATM service provider for the provision of ATM services to its customers; and
the ATM service provider providing ATM services to the customers of the financial institutions, wherein the ATM service provider generates revenue by charging each financial institution an access fee for access to the ATM network and by collecting an interchange fee for each transaction initiated by each of the financial institution's respective customers.

2. The system for providing ATM services of claim 1, wherein a particular financial institution may direct the ATM provider to impose a surcharge fee on the financial institution's customers for services provided by the ATM provider.

3. The system for providing ATM services of claim 1, wherein the network is an EFT network.

4. The system for providing ATM services of claim 1, wherein the EFT network and the ATM services provider are owned by the same entity.

5. The system for providing ATM services of claim 1, wherein the network is subdivided into predetermined geographic regions.

6. The system for providing ATM services of claim 5, wherein each financial institution may contract for the provision of ATM services within selected geographic regions which comprise less than the entirety of the network.

7. The system for providing ATM services of claim 5, wherein the surcharge fee imposed by a particular financial institution on its customers varies from one selected geographic region to another.

8. The system for providing ATM services of claim 1, wherein the access fee charged to each financial institution is charged on a per transaction basis for each transaction initiated by the each of the financial institution's respective customers.

9. The system for providing ATM services of claim 8, wherein the access fees vary depending on the type of transaction performed.

10. The system for providing ATM services of claim 8, wherein the access fees vary depending on the number of transactions performed.

11. The system for providing ATM services of claim 1, wherein the access fee is a flat fee charged on a periodic basis.

12. The system of providing ATM services of claim 1, wherein the access fee charged to the financial institutions by the ATM services provider is based on an amount of usage of the ATM services by customers of the respective financial institution.

13. The system for providing ATM services of claim 1, wherein the ATMs provided by the ATM provider have distinguishing characteristics making the ATMs readily identifiable to customers as belonging to the ATM services provider.

14. The system for providing ATM services of claim 1, wherein the services provided by the ATM provider are selected from the group consisting of cash withdrawal, balance inquires, balance transfers, deposit of currency, and deposit of checks.

15. The system for providing ATM services of claim 1, wherein the ATM services provider also provides check clearing services to the plurality of financial institutions and check deposit services to the customers of the financial institutions.

16. The system for providing ATM services of claim 1, wherein customers of non-participating financial institutions may contract directly with the ATM services provider for access to the services provider's ATM network.

17. The system for providing ATM services of claim 1, wherein customers of participating financial institutions which provide limited ATM access may contract directly with the ATM services provider for access to the services provider's ATM network.

18. A method for providing ATM services to a plurality of financial institutions, wherein each financial institution has a plurality of customers, the method comprising:
providing an ATM services provider, wherein the provider maintains at least two ATMs, which are connected to a network;
contracting with each respective financial institution to provide ATM services to the customers of the financial institution; and
charging each financial institution an access fee for access to the ATM network and collecting an interchange fee for each transaction initiated by each of the financial institution's respective customers.

19. The method for providing ATM services of claim 18, further including the step of charging a surcharge fee to the respective customers of each respective financial institution, at the discretion of each particular financial institution, for services provided by the ATM provider.

20. The method for providing ATM services of claim 18, further including the step of subdividing the network into predetermined geographic regions.

21. The method for providing ATM services of claim 20, further including the step of allowing each financial institution to contract for the provision of ATM services within selected geographic regions which comprise less than the entirety of the network.

22. The method for providing ATM services of claim 21, further including the step of varying the surcharge fee imposed by a particular financial institution on its customers from one selected geographic region to another.

23. The method for providing ATM services of claim 18, further including the step of charging the access fee to each financial institution on a per transaction basis for each transaction initiated by the each of the financial institution's respective customers.

24. The method for providing ATM services of claim 18, further including the step of varying the interchange fees depending on the transaction performed.

25. The method for providing ATM services of claim 18, further including the step of charging each financial institution a flat fee on a periodic basis.

26. The method for providing ATM services of claim 18, further including the step of providing ATMs with distinguishing characteristics which make the ATMs readily identifiable to customers as belonging to the ATM services provider.

27. The method for providing ATM services of claim 18, further including the step of providing ATM services selected from the group consisting of cash withdrawal, balance inquires, balance transfers, deposit of currency, and deposit of checks.

28. The method for providing ATM services of claim 18, further including the step of providing check clearing services to the plurality of financial institutions and providing check deposit services to the customers of the financial institutions.

29. The method for providing ATM services of claim 18, further including the step of providing check cashing services to the plurality of financial institutions and providing check deposit services to the customers of the financial institutions.

30. The method of providing ATM services of claim 18, wherein customers of non-participating financial institutions may contract directly with the ATM services provider for access to the services provider's ATM network.

31. The method of providing ATM services of claim 18, wherein customers of participating financial institutions which provide limited ATM access may contract directly with the ATM services provider for access to the services provider's ATM network.
